(19) United States
(12) Patent Application Publication
(10) Pub. No.: US 2004/0184439 A1
(43) Pub. Date: Sep. 23, 2004

(54) Method for simultaneously accessing circuit services and packet services in a cellular mobile raido system

(75) Inventors: Patrick Blanc, Issy Les Moulineaux (FR); Stanislas Bourdeaut, Paris (FR); Nicolas Drevon, Paris (FR)

Correspondence Address: SUGHRUE MION, PLLC, Suite 800, 2100 Pennsylvania Avenue, N.W., Washington, DC, 20037-3213, US

(73) Assignee: EVOLIUM S.A.S.

(21) Appl. No.: 10/765,132

(22) Filed: Jan. 28, 2004

(30) Foreign Application Priority Data
Jan. 29, 2003 (FR) 03 01 018

(51) Int. Cl. H04J 3/24; H04L 12/66

(52) U.S. Cl. 370/349; 370/352

(57) ABSTRACT

A method for simultaneous access to circuit services and packet services in a cellular mobile radio system comprising second generation cells and third generation cells, in which method, if a packet or a circuit connection is required by a terminal already having a circuit or a packet connection set up in a second generation cell, the method determines whether a change of cell to a third generation cell is possible and, if so, effects said change of cell in order to allow said circuit and packet connections simultaneously in a third generation cell.

The present invention relates generally to mobile radio systems.

Mobile radio systems are generally covered by standards and the corresponding standards published by the corresponding standardization bodies can be consulted for more information.

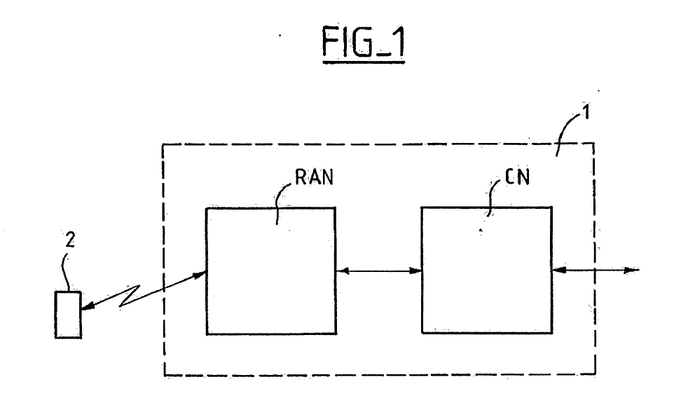

The general architecture of a system is described briefly with reference to FIG. 1. This kind of system comprises a mobile radio network 1 communicating with mobile terminals 2 and with external networks that are not specifically shown. The network 1 itself comprises a radio access network (RAN) 3 that is responsible mainly for transmission and for managing radio resources across the radio interface between the network and the mobile terminals, and a core network (CN) 4 that is responsible mainly for routing and for managing calls. Mobile radio systems have a cellular architecture and mechanisms are provided for continuously selecting for each terminal the best server cell through which to access the network.

Changes in requirements and in technology are leading generally to differentiating different types of services, in particular circuit services and packet services, and different types of systems, in particular second generation systems and third generation systems.

A typical second generation system is the Global System for Mobile communication (GSM), which uses a Frequency Division Multiple Access/Time Division Multiple Access (FDMA/TDMA) radio access technology. Initially, the GSM was essentially intended to provide telephony services by means of a core network technology based on circuit switching (CS) and protocols suited to circuit traffic. Packet services were introduced subsequently, using the General Packet Radio Service (GPRS) function employing a core network technology based on packet switching (PS) and specific protocols suited to packet traffic.

However, second generation systems are not optimized for supporting a circuit connection and a packet connection simultaneously for the same terminal.

In particular, it is not necessarily possible for a user engaged in a circuit connection (for example a telephone call) to initiate a packet connection (for example to access the Internet), or vice versa. Only some more complex and more costly terminals, such as class A terminals or terminals supporting the Dual Transfer Mode (DTM) function are capable of supporting circuit services and packet services simultaneously. Similarly, only some cells, in particular DTM cells supporting the DTM function, can support circuit services and packet services simultaneously, in particular because this requires coordinating the allocation of resources for a circuit connection and for a packet connection for the same terminal, which is not necessarily feasible in all implementations.

Thus, at present, in a GSM-GPRS system:

a user having a terminal other than a class A terminal or a DTM terminal and engaged in a circuit connection must terminate the circuit connection to be able to initiate a packet connection, and

a user having a terminal other than a class A terminal or a DTM terminal and engaged in a packet connection must suspend the packet connection to be able to initiate a circuit connection and must then wait for the circuit connection to be terminated before he can resume the packet session; moreover, even if the user has a DTM terminal and is accessing the network via a DTM cell, he must wait for the circuit connection to be set up before he can resume the packet session.

In contrast, third generation systems have been optimized from the outset to allow multiplexing of different services on the same connection, in particular circuit services and packet services.

The Universal Mobile Telecommunication System (UMTS) is a typical example of a third generation system and uses a Wideband-Code Division Multiple Access (W-CDMA) radio access technology. The UMTS uses both core network technologies (i.e. circuit switching and packet switching), and protocols suited to both circuit traffic and packet traffic.

Accordingly, in a third generation system, such as the UMTS in particular, it is always possible for a user engaged in a circuit connection to initiate a packet connection, or vice versa.

Moreover, at least in their initial deployment phase, third generation networks will rely on existing second generation infrastructures. In other words, the same system may then comprise second generation cells (in particular GSM-GPRS cells) and third generation cells (in particular UMTS cells). Thus it will become beneficial to provide 2G/3G dual-mode mobile terminals, in particular UMTS/GSM-GPRS dual-mode terminals. For services supported in common by both generations, such as telephone services in particular, this makes it possible to extend the coverage of a third generation network by exploiting the existing coverage provided by a second generation network.

The Applicant has observed that a new problem then arises, namely that, with a 2G/3G dual-mode terminal (such as a UMTS/GSM-GPRS terminal), the user may not obtain the same quality of service when the cell through which he accesses the system is a 3G cell (in particular an UMTS cell) and when it is a 2G cell (in particular a GSM-GPRS cell). This is because, as mentioned above, a 3G cell necessarily supports simultaneous circuit services and packet services, whereas a 2G cell does not necessarily support the two types of service simultaneously.

Accordingly, if the terminal and/or the 2G cell through which the terminal accesses the network do not support simultaneous circuit services and packet services, a user has to wait for his circuit connection to be terminated before he can initiate a packet connection. Furthermore, this may occur relatively frequently, since some operators may decide to set up circuit connections automatically via GSM/GPRS cells.

Likewise, if the terminal and/or the 2G cell through which the terminal accesses the network do not support simultaneous circuit services and packet services, the user has to wait for his packet connection to be terminated or interrupted before he can initiate a circuit connection. Moreover, even if the DTM function is supported, in order to initiate a circuit session when a packet session is already in progress, the user must begin by suspending the packet session, and can resume it only when the circuit connection has been set up.

Users may not accept this degraded quality of service, especially as this may come about without them being consulted beforehand (as would be the case with restricted UMTS coverage, for example), and with no adjustment of the charges they pay.

One particular object of the present invention is to solve the above problem and to avoid some or all of the drawbacks mentioned above. A more general object of the present invention is to improve the quality of service in such systems, in this instance to improve the accessibility of services.

One aspect of the present invention consists in a method for simultaneous access to circuit services and packet services in a cellular mobile radio system comprising second generation cells and third generation cells, in which method, if a packet or a circuit connection is required by a terminal already having a circuit or a packet connection set up in a second generation cell, the method determines whether a change of cell to a third generation cell is possible and, if so, effects said change of cell in order to allow said circuit and packet connections simultaneously in a third generation cell.

According to another feature, the network determines if said change of cell is possible.

According to another feature, if said connection already set up in a second generation cell is a circuit connection, said change of cell is an intercellular transfer (handover).

According to another feature, if said connection already set up in a second generation cell is a packet connection, said change of cell is a change of cell ordered by the network.

According to another feature, the terminal signals to the network that a packet or a circuit connection is required simultaneously with a circuit or a packet connection that is already set up and, on receiving said signaling, the network determines if said change of cell is possible.

According to another feature, the terminal signals to the network that a packet connection is required simultaneously with a circuit connection that is already set up by sending the network a request to operate in dual transfer mode.

According to another feature:

a second generation cell not supporting simultaneous circuit services and packet services signals falsely to mobile terminals in said cell that it supports simultaneous circuit services and packet services,

a mobile terminal supporting simultaneous circuit services and packet services and having a circuit connection already set up in said cell signals to the network that a packet connection is required by sending the network a request to operate in dual transfer mode, and

on receiving said signaling, the network determines if said change of cell is possible.

According to another feature, the terminal signals to the network that a circuit connection is required simultaneously with a packet connection that is already set up by sending the network a packet session suspension request.

According to another feature, when said change of cell has been effected, the network initiates automatic setting up of the connection in said third generation cell by sending the terminal a paging message.

According to another feature, when executing said change of cell, said second generation cell sends said third generation cell information necessary for automatically initiating setting up of the connection by the network.

According to another feature, when said change of cell has been effected, the terminal initiates setting up the connection in said third generation cell.

The invention also consists in a mobile radio system comprising means for implementing the above method.

The invention further consists in mobile radio system radio access network equipment including means for implementing the above method.

The invention further consists in mobile radio system core network equipment including means for implementing the above method.

Other objects and features of the present invention will become apparent on reading the following description of an embodiment, which is given with reference to the appended drawings, in which:

FIG. 1 shows the general architecture of a mobile radio system, and

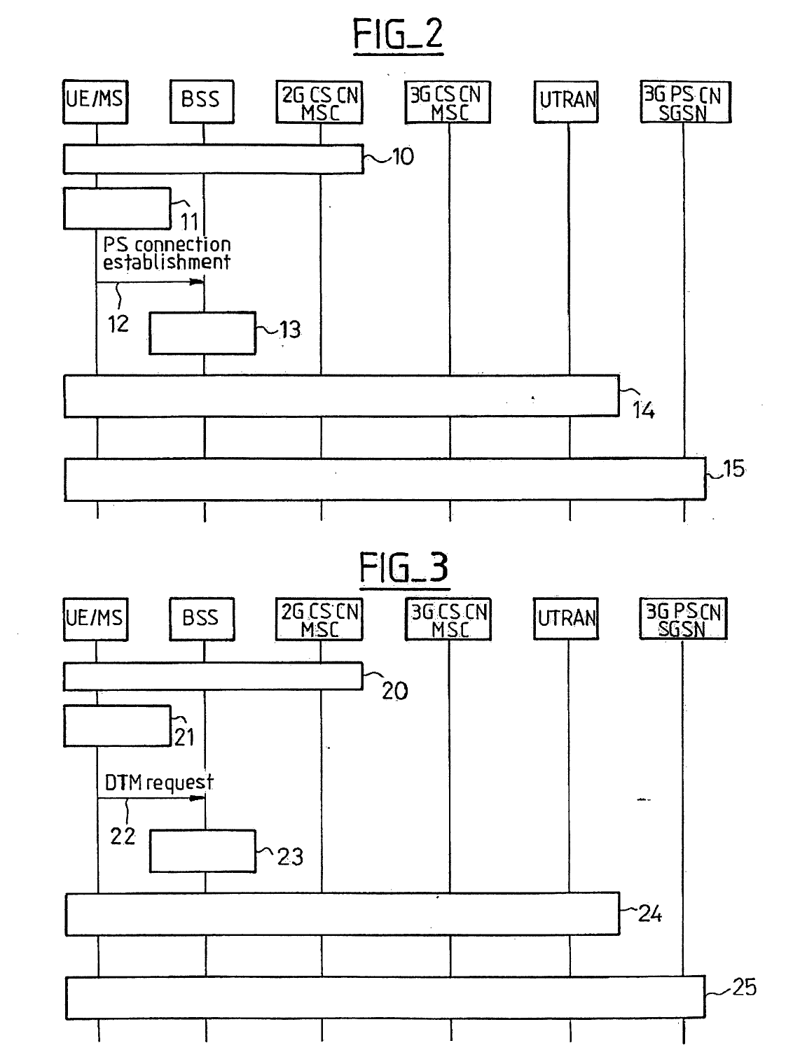

FIGS. 2, 3, 4 and 5 respectively depict first, second, third and fourth implementations of a method of the invention.

In addition to the foregoing description with reference to FIG. 1, it is pointed out that:

in a GSM/GPRS type system, the mobile terminal is called a Mobile Station (MS), the Radio Access Network (RAN) comprises subsystems known as Base Station Subsystems (BSS), and the Core Network (CN) comprises, in the Circuit-Switched (CS) domain, 2G-MSC network elements, where 2G stands for “2^{nd} Generation” and MSC stands for “Mobile Switching Center”, and, in the Packet-Switched (PS) domain, 2G-SGSN network elements, where 2G stands for “2^{nd} Generation” and SGSN stands for “Serving GPRS Support Node”, and

in a UMTS type system, the mobile terminal is called a User Equipment (UE), the Radio Access Network (RAN) is called a UTRAN (UMTS Terrestrial Radio Access Network), and the Core Network (CN) comprises, in the Circuit-Switched (CS) domain, 3G-MSC network elements, where 3G stands for “3^{rd} Generation” and MSC stands for “Mobile Switching Center”, and, in the Packet Switching (PS) domain, 3G-SGSN network elements, where 3G stands for “3^{rd} Generation” and SGSN stands for “Serving GPRS Support Node”.

It is further pointed out that the above systems generally include mechanisms for changing cell, enabling a connection to be maintained when a user moves from an area covered by one cell into an area covered by another cell. The cell change over process is generally divided into two steps: a preparation or decision step, during which it is decided whether a change of cell is possible and desirable, in accordance with various criteria or causes, and if so to which cell it should be effected, known as the target cell, and an execution step of switching to the selected target cell.

In the case of a circuit connection, this kind of change of cell is effected by an intercellular transfer process known as handover. In this case, a handover decision is taken by the network, generally on the basis of radio measurement results reported to the network by the mobile terminal (for this reason this technique is known as Mobile-Assisted HandOver (MAHO)) and another criterion (for example, traffic load), and the network reserves resources in the target cell in advance, before switching to the target cell.

In the case of a packet connection, this kind of change of cell is effected by a cell reselection process. There are generally several cell reselection control modes, corresponding to decreasing levels of autonomy of the mobile terminal or increasing levels of control by the network (which amounts to the same thing). In the case of the GPRS, for example, those control modes include NC0 and NC1 control modes for cell reselection controlled by the mobile terminal and an NC2 control mode for cell reselection controlled by the network. Moreover, the cell reselection technique used in the case of a packet connection requires no advance reservation of resources in the target cell; to the contrary, the terminal itself requests resources in the target cell by normal packet mode access to the selected target cell using one or the other of the above control modes.

From the system architecture point of view, a distinction is drawn between different types of cell change, in particular according to whether the original cell and the target cell use the same radio access technology, such as the 2G or 3G technology. The situation in which the original cell and the target cell use different radio access technologies is known as an Inter-Radio Access Technology (Inter-RAT) cell change. In particular mechanisms are provided for 2G to 3G handover or for cell reselection ordered by the network.

If a circuit or a packet connection has already been set up for a 2G/3G dual mode terminal (such as a UMTS/GSM-GPRS terminal, also referred to as a UE/MS terminal) in a 2G cell (such as a GSM-GPRS cell), and a simultaneous packet or circuit connection is requested for the same terminal, the invention proposes to determine whether a change of cell to a 3G cell (such as a UMTS cell) is possible and, if so, to execute the cell change in order to support the two connections simultaneously in a 3G cell.

In other words, one aspect of the invention lies in the introduction of a new cause for cell change, in particular a new cause for 2G to 3G handover or a new cause for 2G to 3G cell change ordered by the network.

The invention applies equally to a change of cell controlled by the network, whether assisted by the terminal or not, and to a change of cell controlled by the terminal, whether assisted by the network or not.

Moreover, the invention applies equally to a terminal already engaged in a circuit connection and requiring to engage in a simultaneous packet connection and to a terminal already engaged in a packet connection and requiring to engage in a simultaneous circuit connection.

Moreover, the invention applies equally to the situation in which the request for a connection simultaneous with a connection already set up is made at the initiative of the terminal, which is known as “Mobile Originating”, and to the situation in which the request is not made at the initiative of the terminal, which is known as “Mobile Terminating”.

Moreover, if the request for a connection simultaneous with a connection that has already been set up is made at the initiative of the terminal, the invention proposes authorizing the terminal to indicate to the network that it wishes to engage in a packet connection when it is already engaged in a circuit connection, or vice versa. On the basis of this kind of indication, the network can then decide whether a cell change to a 3G cell is possible and desirable and, if so, it can execute the cell change in order to provide simultaneous circuit and packet connections in a 3G cell.

Moreover, the present invention proposes different methods for this kind of signaling, depending on the version of the standard that applies, whether that version is a future version (3GPP R6 et seq.) or the current version (3GPP R99).

A first embodiment corresponding to a situation where a UE/MS terminal already engaged in a circuit connection requires to engage in a packet connection and to future versions of the standard is described next with reference to FIG. 2.

In FIG. 2, in an initial step 10, a UE/MS terminal is engaged in a circuit connection with a GSM-GPRS network. Remember that, in a circuit connection, the terminal has a signaling link with the BSS via a radio resource (RR) connection and a signaling link with a core network element (2G-MSC) via a MM or GMM connection, where (G)MM stands for “(GPRS) Mobility Management”.

In a step 11, a decision to request a packet connection is taken in the UE/MS terminal (either by the user or by the application).

The UE/MS terminal can then signal to the GSM/GPRS network (BSS or 2G-MSC) that it wishes to set up a packet connection. It may be advantageous to signal this to the BSS, as the BSS has a better overview for deciding whether a cell change to the UMTS is possible and desirable, in particular thanks to radio measurements that are reported back to it by the UE/MS; nevertheless, the situation of signaling to the CN is not excluded.

Accordingly, if setting up a packet connection is requested when the UE/MS terminal is already engaged in a circuit connection, the UE/MS terminal sends the network (BSS or MSC), via the corresponding signaling link (RR signaling link or MM signaling link), a “PS Connection Establishment Request” message to indicate the requirement to set up a packet connection, as shown by a step 12, in the situation of signaling to the BSS, for example.

In a step 23, the reception of the above message by the network (by the BSS in the FIG. 2 example) triggers a process of deciding on handover to the UTRAN and on target UMTS cell selection. This kind of process can comprise some or all of the following steps:

the network verifies that the terminal has the capacities required to access a third generation cell (in order words, that the terminal is a 2G/3G dual-mode terminal),

the network verifies whether this kind of handover is possible and desirable on the basis of radio measurements previously reported back to the network for UMTS cells, and possibly on the basis of other criteria, and

the network selects a target UMTS cell on the basis of the radio measurements; if no radio measurements are available, the network can select a target UMTS cell specified by Operation & Maintenance (O&M) or request the UE/MS terminal to carry out radio measurements on UMTS cells, for example.

If after step 13 the GSM-GPRS network has decided that handover to the UTRAN is possible and desirable, the next step is a step 14 that effects the handover. This step can be executed in the usual way and consequently it is not described in detail here. Suffice to say that, according to the 2G to 3G intersystem handover process specified in the GERAN/3GPP standard, the GSM-GPRS network starts by reserving resources in the target UMTS cell. If resources are available for the handover in the target UMTS cell, the GSM-GPRS network is informed of this and then requests the UE/MS terminal to effect the handover.

The invention further proposes that the GSM-GPRS network inform the UMTS network, during the step of executing the handover, that the UE wishes to set up a simultaneous packet connection in the target cell, in particular in a handover preparation message. This would allow the UMTS network to trigger the sending of a paging message to the UE and would avoid the UE having to memorize its PS connection request in order to renew it after the transfer to the target cell.

The final step depicted in FIG. 2 is a step 15 of setting up in the target UMTS cell a packet connection simultaneously with the circuit connection. As indicated hereinabove, one option is for this step to be initiated by the UMTS network, based on the GSM-GPRS network sending appropriate signaling to the UMTS network. Another option is for this step to be initiated by the UE/MS terminal, based on repetition of the packet connection request by the user or by the application. Once initiated in either of the above ways, the step 15 can be carried out in the usual way, and consequently is not described in detail here.

Note that the “PS Connection Establishment Request” message the terminal sends the network in step 12 does not exist in the current version of the standard. One aspect of the invention lies in the introduction of this new form of signaling. Another aspect of the invention lies in the introduction of a new cause of intersystem handover to the UTRAN, as indicated above.

A second embodiment is described in more detail below with reference to FIG. 3, corresponding to the situation of a UE/MS terminal that is already engaged in a circuit connection and requires to engage in a packet connection, and to the current version of the standard.

In this case, as described below, another aspect of the invention lies in the option of triggering handover to the UMTS even with a UE/MS terminal that conforms to the current version (R99) of the standard, i.e. one that does not support the new form of signaling introduced in relation to the FIG. 2 example.

The basic principle consists in the network falsely indicating support for the DTM function. Remember that, for a DTM terminal engaged in a circuit connection, if the server cell indicates that it supports the DTM function, the terminal can request the setting up of a packet connection simultaneous with the circuit connection already set up by sending the BSS a request to operate in DTM mode, in the form of a “DTM Request” message, on the RR signaling link associated with the CS connection. Most DTM terminals will be 2G/3G dual-mode terminals; accordingly, the BSS could trigger a 2G to 3G intersystem handover as soon as a 2G/3G terminal sends a “DTM Request” message. For DTM terminals that are not 2G/3G dual-mode terminals, the BSS would not respond to this “DTM Request” message. To avoid wasting signaling resources, means could then be provided to prevent the “DTM Request” message from being repeated indefinitely.

Thus the proposed method does not apply to:

MS terminals that support the DTM function but are not UMTS/GSM-GPRS dual-mode terminals, and

UE/MS terminals that do not support the DTM function.

To be more precise, the method could comprise the steps shown in FIG. 3, for example.

In a step 20, a circuit connection is in progress for a UE/MS terminal supporting the DTM function in a cell falsely indicating that it supports the DTM function. This kind of false indication of DTM support could therefore be broadcast by the BSS in each GSM-GPRS cell in the vicinity of at least one UMTS cell.

In a step 21, the UE/MS terminal decides to set up a simultaneous packet connection.

In a step 22, the UE/MS terminal sends the BSS a “DTM Request” message. According to the 3GPP Technical Specification TS 04.18, the terminal triggers a time delay (this is the time delay T3148 defined in the above specification) at the same time as sending a “DTM Request” message.

In a step 23, the BSS, which knows that the terminal is a 2G/3G terminal, triggers a process of deciding to handover to the UTRAN and selecting a target UMTS cell; this process can be similar to that described for step 13 in FIG. 2.

If, after step 23, the GSM-GPRS network has decided that handover to the UTRAN is possible and desirable, the next step is a step 24 that executes the handover. This step can be executed in the usual way and consequently is not described in detail here. Suffice to say that, in accordance with the 2G to 3G intersystem handover process specified in the GERAN/3GPP standard, this step includes sending the terminal an “Intersystem to UTRAN Handover Command” message before said time delay expires. On receiving this message, the terminal terminates said time delay and thereby abandons the packet mode access procedure initiated in the 2G cell, in order to obey the command to execute the handover to the UTRAN.

The final step depicted in FIG. 3 is a step of setting up a packet connection simultaneous with the circuit connection in the target UMTS cell. This step 25 can be similar to the step 15 in FIG. 2.

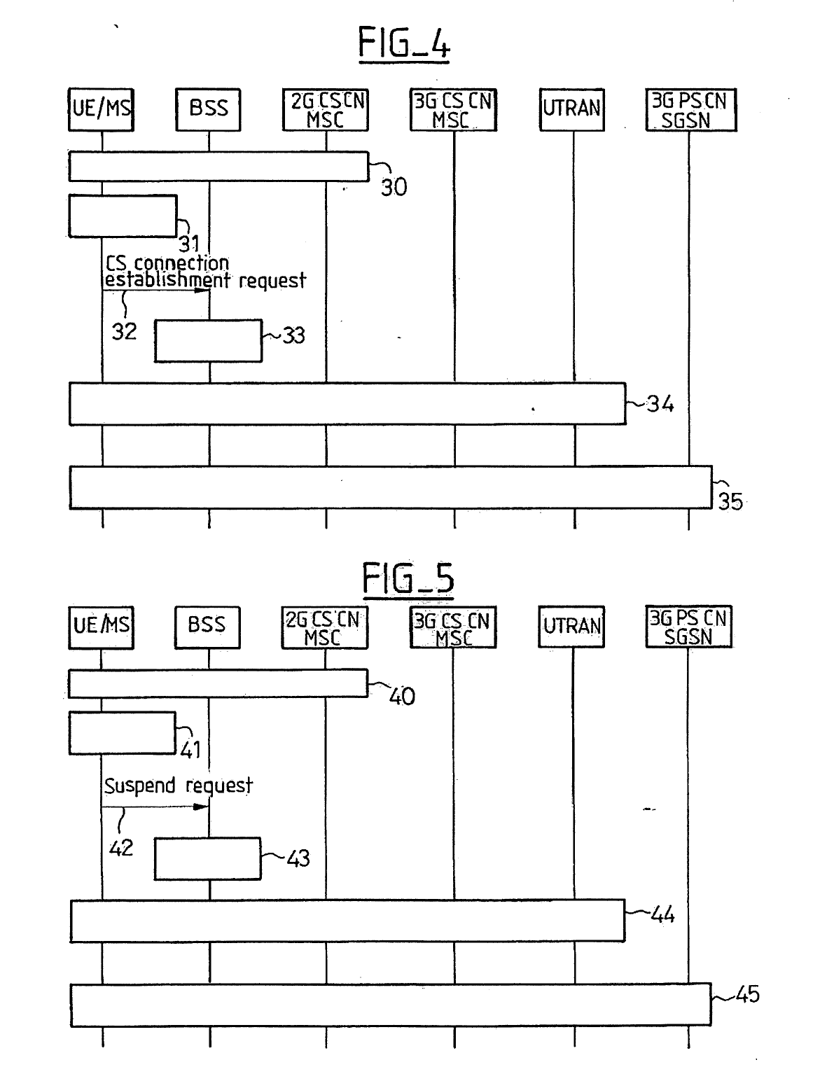

A third embodiment is described in more detail next with reference to FIG. 4, corresponding to the situation of a UE/MS terminal already engaged in a packet connection and requiring to engage in a circuit connection, and to future versions of the standard.

A step 30 is an initial step in which a UE/MS terminal is engaged in a packet connection with a GSM-GPRS network. Remember that in this kind of packet connection the terminal has a signaling link with the BSS via a packet mode Temporary Block Flow (TBF) connection and a signaling link with a core network element or 2G-SGSN via a mobility management or GMM context.

In a step 31, a decision to request a circuit connection is taken in the terminal, either by the user or by the application.

The UE/MS terminal can then signal to the GSM/GPRS network (BSS or 2G-SGSN) that it requires to set up a circuit connection. It may be advantageous to signal this to the BSS as the BSS has a better overview for deciding if a change of cell to the UMTS is possible and desirable (in particular thanks to radio measurements that are reported back to it by the UE/MS terminal); however, the situation of signaling to the CN is not excluded.

Accordingly, if the user requires to set up a circuit connection when the UE/MS terminal is already engaged in a packet connection, the UE/MS terminal sends the network (BSS or 2G-SGSN), via the corresponding signaling link (TBF signaling link or GMM signaling link), a “CS Connection Establishment Request” message to indicate the requirement to set up a CS connection, as shown in a step 32 for signaling to the BSS, for example.

In a step 33, on receipt of this message by the network (by the BSS in this example, but more generally by the BSS or the 2G-SGSN), a process is triggered to decide on a cell change to the UTRAN ordered by the GSM-GPRS network and select a target UMTS cell; the cell reselection mode is then the NC2 mode, and this decision and target cell selection process can employ criteria similar to those described with reference to step 13 in FIG. 2, for the handover situation.

If, at the end of the step 33, the GSM-GPRS network has decided that a cell change to the UTRAN ordered by the network is possible and desirable, the next step is a step 34 in which this change of cell ordered by the network is effected. This step can be executed in the usual way and consequently is not described in detail here.

The invention further proposes that the GSM-GPRS network be able to indicate to the UMTS network, during this cell change execution step, that the UE wishes to set up a simultaneous circuit connection in the target cell, in particular in a cell change preparation message. This would allow the UMTS network to trigger sending a paging message to the UE and would avoid the UE having to memorize its circuit connection request in order to renew it after the switch to the target cell.

The final step shown in FIG. 4 is a step 35 of setting up simultaneous circuit and packet connections in the target UMTS cell. As indicated above, one option is for this step to be initiated by the UMTS network, based on the GSM-GPRS network sending appropriate signaling to the UMTS network. Another option is for this step to be initiated by the UE/MS terminal, based on repetition of the circuit connection request by the user or by the application. Once initiated in either of the above ways, the step 35 can be executed in the usual way, and consequently is not described in detail here.

A fourth implementation is described below with reference to FIG. 5, corresponding to the situation of a UE/MS terminal already engaged in a packet connection and requiring to engage in a circuit connection, and to the current version of the standard.

In this case, another aspect of the invention lies in the option to trigger a cell change to the UTRAN even with a UE/MS terminal conforming to the current version (R99) of the standard, i.e. one not supporting the new form of signaling introduced in relation to the FIG. 4 example.

The idea is that the packet session suspension (“Suspend Request”) message, usually sent by the terminal (MS) to the network (2G-SGSN) if the terminal and/or the cell through which the terminal is accessing the network do not support simultaneous circuit services and packet services, can be used to indicate to the network that a circuit connection simultaneous with a packet connection is requested. On the basis of this indication, the network can then decide whether a cell change to a 3G cell is possible and desirable, in order to set up the two simultaneous connections in a 3G cell.

To be more precise, the method could comprise the steps shown in FIG. 5, for example:

in a step 40, there is already a packet connection for a UE-MS terminal in a GSM-GPRS cell,

in a step 41, a decision to set up a simultaneous circuit connection is taken in the terminal,

in a step 42, the UE/MS terminal sends the 2G-SGSN a “Suspend Request” message,

in a step 43, the BSS decodes the “Suspend Request” message and a decision for cell change to the UTRAN ordered by the network can then be taken, for example in a similar manner to that described for the step 33 in FIG. 4,

if, after the step 43, a decision has been taken to effect a cell change to the UTRAN ordered by the network, then a step 44 is executed to effect the cell change ordered by the network, for example in a similar manner to that described for the step 34 in FIG. 4, and

a final step 45 sets up a circuit connection simultaneous with the packet connection in the target UMTS cell (this step can be similar to the step 35 in FIG. 4).

The present invention also provides a mobile terminal for a mobile radio system, a radio access network equipment for a mobile radio system, and a core network equipment for a mobile radio system all comprising means for implementing the above kind of method.

The particular implementation of such means representing no particular difficulty for the person skilled in the art, such means do not need to be described here in more detail than by stating their function, as above.

What is claimed is:

1. A method for simultaneous access to circuit services and packet services in a cellular mobile radio system comprising second generation cells and third generation cells, in which method, if a packet or a circuit connection is required by a terminal already having a circuit or a packet connection set up in a second generation cell, the method determines whether a change of cell to a third generation cell is possible and, if so, effects said change of cell in order to allow said circuit and packet connections simultaneously in a third generation cell.

2. A method according to claim 1, wherein the network determines if said change of cell is possible.

3. A method according to either claim 1 or claim 2, wherein, if said connection already set up in a second generation cell is a circuit connection, said change of cell is an intercellular transfer (handover).

4. A method according to either claim 1 or claim 2, wherein, if said connection already set up in a second generation cell is a packet connection, said change of cell is a change of cell ordered by the network.

5. A method according to any one of claims 1 to 4, wherein the terminal signals to the network that a packet or a circuit connection is required simultaneously with a circuit or a packet connection that is already set up and, on receiving said signaling, the network determines if said change of cell is possible.

6. A method according to claim 5, wherein the terminal signals to the network that a packet connection is required simultaneously with a circuit connection that is already set up by sending the network a request to operate in dual transfer mode.

7. A method according to claim 6, wherein:
a second generation cell not supporting simultaneous circuit services and packet services signals falsely to mobile terminals in said cell that it supports simultaneous circuit services and packet services,
a mobile terminal supporting simultaneous circuit services and packet services and having a circuit connection already set up in said cell signals to the network that a packet connection is required by sending the network a request to operate in dual transfer mode, and
on receiving said signaling, the network determines whether said change of cell is possible.

8. A method according to claim 5, wherein the terminal signals to the network that a circuit connection is required simultaneously with a packet connection that is already set up by sending the network a packet session suspension request.

9. A method according to any one of claims 1 to 8, wherein, when said change of cell has been effected, the network initiates automatic setting up of the connection in said third generation cell by sending the terminal a paging message.

10. A method according to claim 9, wherein, when executing said change of cell, said second generation cell sends said third generation cell information necessary for automatically initiating setting up of the connection by the network.

11. A method according to any one of claims 1 to 8, wherein, when said change of cell has been effected, the terminal initiates setting up the connection in said third generation cell.

12. A mobile radio system mobile terminal including means for implementing a method according to any one of claims 1 to 11.

13. Mobile radio system radio access network equipment including means for implementing a method according to any one of claims 1 to 11.

12. Mobile radio system core network equipment including means for implementing a method according to any one of claims 1 to 11.
